(19) United States
(12) Patent Application Publication
(10) Pub. No.: US 2006/0119727 A1
(43) Pub. Date: Jun. 8, 2006

(54) Non-linear display mapping for sensor systems

(75) Inventor: John D. O'Connor, Springfield, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: UNITED STATES OF AMERICA AS REPRESENTED BY THE DEPT OF THE ARMY

(21) Appl. No.: 11/006,670

(22) Filed: Dec. 8, 2004

(51) Int. Cl. H04N 5/222

(52) U.S. Cl. 348/333.01

(57) ABSTRACT

The invention allows a user to determine the signal intensity of any region of a sensor's (FLIR) output by real-time manipulation of the histogram of pixel values. As the user manipulates a displayed histogram, changes to the display output would be immediately visible and completely fluid. A single slider or scalar joystick button would be the sensor control necessary, thereby eliminating brightness and contrast controls. Thresholding, equalization and any other manipulation of the sensor output, can be employed to support any task under any condition in any environment. Such a control would allow the user to rapidly optimize the dynamic range of any part or parts of the sensor's output.

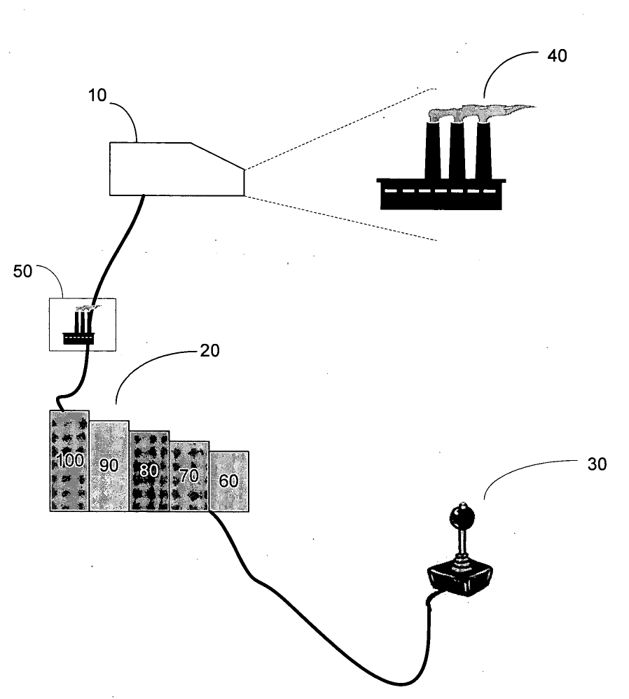

### GOVERNMENT INTEREST

The invention described herein may be manufactured, used, sold, imported, and/or licensed by or for the Government of the United States of America.

### FIELD OF THE INVENTION

The present invention generally relates to tuning thermal image displays.

### BACKGROUND OF THE INVENTION

Imaging systems were originally analog systems until the advent of digital technology. Thus, manipulation of a displayed image was limited to analog controls, such as brightness and contrast. The modern digital Forward Looking Infrared (FLIR) outputs digital information for each displayed pixel with three data dimensions: X location, Y location, and intensity. Intensity, usually measured in 12 bits, is mapped to a display as grayscale values, currently 8 bits. Thus, the brightness and contrast has been adjusted by using this limited grayscale. This limits the amount of adjustment that can be made to the display.

Currently, no algorithm exists that can optimize thermal displays for every environment, condition, and target. The commonly available manual brightness and contrast controls, typically the alternative provided for the use when “auto mode” does not work well, are difficult to use and do not fully realize the potential of digital systems.

Also, as recent experiments have shown,, the auto mode may combine contrast shades such that targets are hidden, and the problem is not visible to the observer.

Accordingly, there is in a need in the prior to make manipulate a sensor's output in real time and to eliminate analog type adjustments to the display such as brightness and contrast. The present invention addresses this need.

### SUMMARY OF THE INVENTION

One object of the present invention is to eliminate analog type adjustments to the display such as brightness and contrast. This is achieved by allowing a user to determine the signal intensity of any region of a sensor's output by real-time manipulation of the histogram of pixel values. As the user manipulates a displayed histogram, changes to the display output would be immediately visible and completely fluid. A single slider or scalar joystick button would be the sensor control necessary, thereby eliminating brightness and contrast controls. Thresholding, equalization and any other manipulation of the sensor output, can be employed to support any task under any condition in any environment. Such a control would allow the user to rapidly optimize the dynamic range of any part or parts of the sensor's output. For example, if the critical information were contained in the 1^{st} and 12^{th} bits, the use could employ maximum potential of the 8 bit dynamic range of his display to those bits. The advantages of such a control would be equally useful for nearly any wavelength imaging system, as well as single or multi-band systems.

### BRIEF DESCRIPTION OF THE DRAWINGS

The foregoing and other objects, aspects and advantages will be better understood from the following detailed description of the invention with reference to the drawings, in which:

The FIGURE shows a schematic view of the present invention.

### DETAILED DESCRIPTION OF THE INVENTION

Non-linear Display mapping (NDM) is a method of high-speed digital signal processing which provides the use a means to quickly manipulate displayed image parameters with the goal of improving image understanding. NDM allows the user to determine the relative signal intensity by real time non-linear mapping of the pixel values. The user can thus allocate or “tune” pixel intensities (grayshades) to output regions that reflect his expectations of where targets should be, and avoid squandering the system's limited dynamic range on image features like cold, sky, clouds, trees or water. In other words, the user tunes the sensor to the scene.

Current display algorithms employ a wide variety of methods, including histogram equalization, local area processing, and region of interest processing. None of these methods are tunable to the task requirements, (i.e. detection, recognition, identification), or environmental conditions. Further, the current brightness and contrast controls are a holdover from analog technology, and limits the user's ability to manipulate digital sensor output.

This is achieved by the present invention by allowing a user to determine the signal intensity of any region of a sensor's output by real-time manipulation of the histogram of pixel values. As shown in the FIGURE, a Forward Looking Infrared laser 10 takes an image of target 40 and the image is displayed by display 50. A histogram of the pixel values of the image 20 is established and formed such that a joystick 30 or scale (not shown) can change the pixel values by moving the joystick. In changing the pixel values in this manner, the user manipulates the image of the target such that anything obscuring the target can be removed or lessened. As the user manipulates a displayed histogram, changes to the display output would be immediately visible and completely fluid. A single slider or scalar joystick button 30 would be the sensor control necessary, thereby eliminating brightness and contrast controls. Thresholding, equalization and any other manipulation of the sensor output, can be employed to support any task under any condition in any environment. Such a control would allow the user to rapidly optimize the dynamic range of any part or parts of the sensor's output. For example, if the critical information were contained in the 1^{st} and 12^{th} bits, the user could employ maximum potential of the 8 bit dynamic range of the display to those bits. The advantages of such a control would be equally useful for nearly any wavelength imaging system, as well as single or multi-band systems.

The fundamental features of the present invention that are believed to be new are the utilization of high-speed digital data manipulation by the user to achieve the optimum sensor performance for the task or condition at hand. In other words, the user can tune the sensor to display the information in its most relevant form. This is not related to any algorithm or local area processing method, but rather allows the user to quickly create any number of intensity-mapping schemes to meet his immediate needs.

While this invention has been described in terms of preferred embodiment consisting of a one piece assembly made a number of critically arranged elements, those skilled in the art will recognize the true scope of the invention as defined in the claims that follow.

1. A non-linear display mapping device comprising:
an imaging sensor;
a display for displaying the image taken by the imaging sensor;
means to map a real time non-linear map of the pixel values said means connected to the display, wherein the relative signal intensity of the pixel values is established; and
means to directly change the pixel values of means to map in real time.

2. The mapping device of claim 1 wherein the imaging sensor is a forward-looking infrared sensor.

3. The mapping device of claim 1 wherein the imaging sensor is a multi-band sensor.

4. The mapping device of claim 1 wherein the means to directly change the pixel values is a joystick.

5. The mapping device of claim 1 wherein the means to directly change the pixel values is a scale.

6. The mapping device of claim 1 wherein the means to map a real time non-linear map of the pixel values is a histogram of pixel values.

7. A method to establish a non-linear display map comprising the steps of:
providing an imaging sensor;
providing a display for displaying the image taken by the imaging sensor;
mapping a real time non-linear map of the pixel values said means connected to the display, wherein the relative signal intensity of the pixel values is established; and
directly changing the pixel values of the non-linear map in real time.

8. The method of claim 7 wherein the imaging sensor is a forward-looking infrared sensor.

9. The method of claim 7 wherein the imaging sensor is a multi-band sensor.

10. The method of claim 7 wherein the direct changes to the pixel values is done with a joystick.

11. The method of claim 7 wherein the direct changes to the pixel values is done with a scale.

12. The method of claim 7 wherein mapping the real time non-linear map of the pixel values is accomplished by establishing a histogram of pixel values.
